(19) United States
(12) Patent Application Publication
(10) Pub. No.: US 2018/0348676 A1
(43) Pub. Date: Dec. 6, 2018

(54) FIXING DEVICE

(71) Applicant: CANON KABUSHIKI KAISHA, Tokyo (JP)

(72) Inventors: Takao Kume, Yokohama-shi (JP); Masahito Omata, Yokohama-shi (JP); Yasuhito Minamishima, Odawara-shi (JP)

(21) Appl. No.: 15/992,800

(22) Filed: May 30, 2018

(30) Foreign Application Priority Data
May 31, 2017 (JP) 2017-107780

(51) Int. Cl. G03G 15/20

(52) U.S. Cl. CPC G03G 15/205; G03G 2215/2009; G03G 15/2089

(57) ABSTRACT

A fixing device includes a heat generating member extending in a longitudinal direction and having a first region and a second region, an endless belt, an opposing member opposing the endless belt, a heat conductive member extending in the longitudinal direction within the first region in which a surface of the heat conductive member contacts the heat generating member, a positioning portion extending from an end portion of the surface, an electric power shut-off member provided at a position corresponding to the second region, and a supporting member provided with an opening at a position corresponding to the second region and configured to support the heat generating member through the heat conductive member. The opening is configured to permit insertion of the positioning portion to prevent movement of the heat conductive member.

### FIELD OF THE INVENTION AND RELATED ART

The present invention relates to a fixing device for use with an image forming apparatus, such as a copying machine or a laser beam printer, employing an image forming process of an electrophotographic type, an electrostatic recording type or the like.

As a type of the fixing device, a film fixing type using a ceramic heater has been known. Further, conventionally, a countermeasure against “offset of end portion position due to non-sheet-passing-portion temperature rise” has been considered. That is, when a small-sized paper (recording material) is passed through the fixing device, in an end portion region in which the recording material is not passed through the fixing device, an amount of heat from a heat generating member is accumulated as it is, and the end portion region is very high in temperature in some cases. In such a state, in the case where a plain paper-sized (large-sized) recording material is passed through the fixing device, such a hot-offset phenomenon that toner is excessively melted in the end portion region and thus deposits on a fixing film surface and then adheres to the fixing film surface when the fixing film is rotated through one-full circumference generates in some instances.

Therefore, in order to reduce a degree of generation of this phenomenon, a constitution in which between a heat generating member and a holding member for holding the heat generating member, a member having a larger thermal conductivity than a base material of the heat generating member is provided on an entire region of a back surface of the heat generating member has been known (Japanese Laid-Open Patent Application Hei 11-260533). By this constitution, an amount of heat generating at an end portion position is distributed and a temperature of the heat generating member in the end portion position is decreased, so that a degree of non-sheet-passing-portion temperature rise is alleviated and thus generation of the hot-offset phenomenon can be prevented.

However, in this constitution, as a heat conductive member, a member formed of metal, such as an aluminum plate is used, and the heat conductive member expands and contracts by heating, and therefore, there is a need that the heat conductive member is positioned relative to a supporting member for supporting a heater as the heat generating member. For that purpose, when the holding member is provided with a positioning hole separately from a placement window for an electric power shut-off member, strength of the supporting member weakens from the positioning hole which is a starting point, so that deformation due to a sag of the supporting member generates in the neighborhood of the positioning hole in some cases.

### SUMMARY OF THE INVENTION

A principal object of the present invention is to provide a fixing device capable of suppressing deformation of a supporting member, for supporting a heat generating member, in order to position a heat conductive member.

According to an aspect of the present invention, there is provided a fixing device comprising: an elongated heat generating member extending in a longitudinal direction and having a first region and a second region different in the longitudinal direction; an endless belt rotatable in contact with the heat generating member; an opposing member opposing the endless belt and configured to form a nip in cooperation with the endless belt so that a recording material on which a toner image is carried is nipped and fed in the nip; a heat conductive member extending in the longitudinal direction within the first region in which a surface of the heat conductive member contacts the heat generating member; a positioning portion extending from an end portion of the surface of the heat conductive member with respect to the longitudinal direction, in a direction in which the positioning portion is spaced from the heat generating member; an electric power shut-off member provided at a position corresponding to the second region of the heat generating member and configured to shut off electric power supplied to the heat generating member; and a supporting member provided with an opening at a position corresponding to the second region and configured to support the heat generating member through the heat conductive member, wherein the opening is configured to permit insertion of the positioning portion to prevent movement of the heat conductive member.

Further features of the present invention will become apparent from the following description of exemplary embodiments with reference to the attached drawings.

### BRIEF DESCRIPTION OF THE DRAWINGS

FIG. 1 is a schematic sectional view for illustrating a structure of a fixing device according to First Embodiment of the present invention.

FIG. 2 is a schematic front view for illustrating the structure of the fixing device according to First Embodiment of the present invention.

FIG. 3 is an illustration of a ceramic heater.

FIG. 4 is an illustration of a thermistor and a thermo-switch.

In FIG. 5, part (a) is a schematic view for illustrating a holding method of the heater and a metal plate in First Embodiment, part (b) is a schematic view for illustrating holding method of the metal plate, and part (c) is a perspective view for illustrating an engaging portion of the position.

In FIG. 6, part (a) is an illustration of an energizing connector as a heater holding member, and part (b) is an illustration of a heater clip as the heater holding member.

In FIG. 7, part (a) is a schematic sectional view for illustrating positions of the heater and the metal plate in First Embodiment, and part (b) is a schematic sectional view of the thermo-switch.

In FIG. 8, part (a) is a schematic view for illustrating a holding method of a heater and a metal plate in a comparison example, part (b) is a schematic view for illustrating a holding method of the metal plate in the comparison example, and part (c) is a perspective view for illustrating an engaging portion of the metal plate in the comparison example.

FIG. 9 is a schematic sectional view of a thermo-switch portion in the comparison example.

FIG. 10 is a graph showing roller back surface temperature changes at positions of the thermo-switches in First Embodiment and the comparison example.

FIG. 11 is a graph showing heat profiles on heater surfaces in First Embodiment and the comparison example.

In FIG. 12, part (a) is a schematic view for illustrating a holding method of the heater and a metal plate in Second Embodiment, part (b) is a schematic view for illustrating holding method of the metal plate, and part (c) is a perspective view for illustrating an engaging portion of the position.

In FIG. 13, part (a) is a schematic sectional view for illustrating positions of the heater and the metal plate in Second Embodiment, and part (b) is a schematic sectional view of the thermo-switch.

FIG. 14 is a graph showing roller back surface temperature changes at positions of the thermo-switches in Second Embodiment and the comparison example.

FIG. 15 is a graph showing heat profiles on heater surfaces in Second Embodiment and the comparison example.

### DESCRIPTION OF EMBODIMENTS

Embodiments of the present invention will be described with reference to the drawings.

### Embodiment 1

### (Fixing Device)

In the following description, a longitudinal refers to a direction (first direction) perpendicular to a recording material conveyance direction in a recording material conveying path. A short side direction is the same direction as the recording material feeding direction (second direction crossing perpendicular to the first direction).

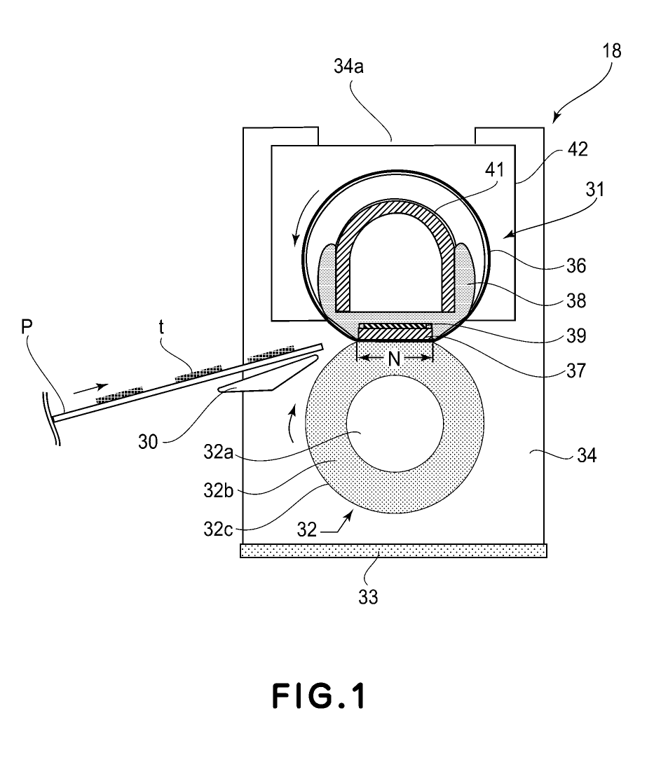

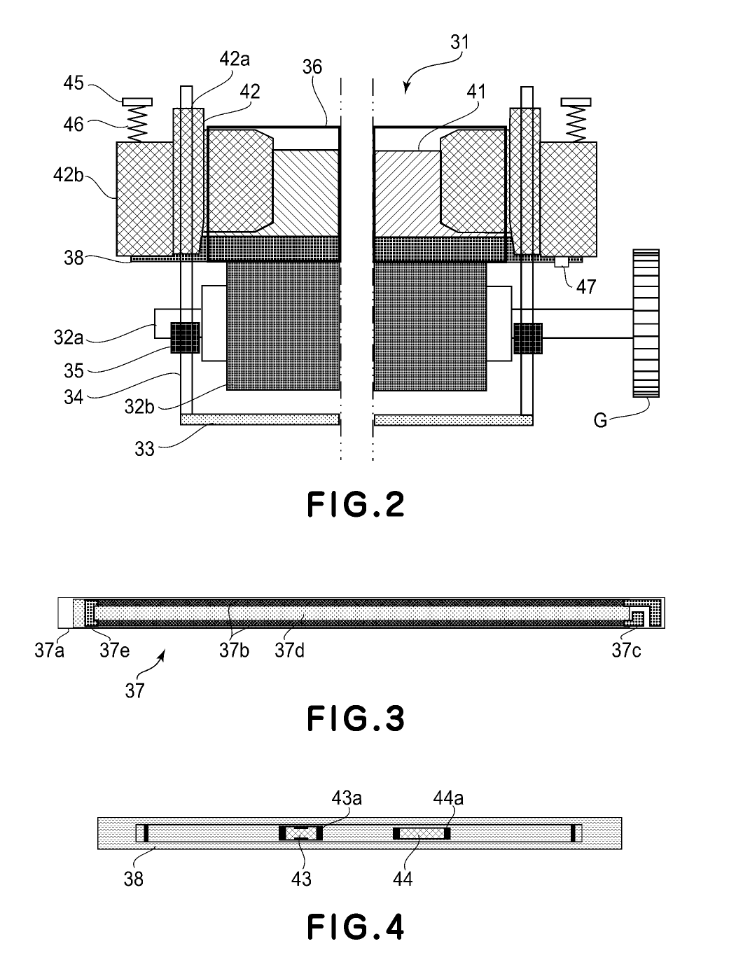

FIG. 1 is a schematic sectional view of a fixing device 18 in this embodiment as seen from the longitudinal direction of the fixing device 18, and FIG. 2 is a schematic view of the fixing device 18 at end portions of the fixing device 18.

The fixing device 18 includes a film unit 31 including a cylindrical film (endless belt) 36 having flexibility and includes a pressing roller 32 as a pressing member. The film unit 31 and the pressing roller 32 are provided in substantially parallel to each other between left and right side plates 34 of a device frame 33 so that a heater 37 opposes the pressing roller 32 through the rotatable sheet 36.

The pressing roller 32 includes a core metal 32a, an elastic layer 32b formed outside the core metal 32a, and a parting layer 32c formed outside the elastic layer 32b. This pressing roller 32 is provided as an opposing member opposing the film 36 backed up by the heater 37 and form a nip N, for nipping and feeding a recording material carrying thereon a toner image, in cooperation with the film 36. As a material of the elastic layer 32b of the pressing roller 32, silicone rubber, fluorine-containing rubber or the like is used. As a material of the parting layer, PFA (tetrafluoroethylene-perfluoroalkylvinyl ether copolymer), PTFE (polytetrafluoroethylene) or FEP (tetrafluoroethylene-hexafluoropropylene copolymer) or the like is used.

In this embodiment, the pressing roller 32 prepared by forming an about 3.5 mm-thick silicone rubber elastic layer 32b on a stainless steel-made core metal 32a of 11 mm in outer diameter by injection molding and then by coating an outside of the layer 32b with an about 40 μm-thick PFA resin tube as a parting layer 32c was used. An outer diameter of the pressing roller 32 is 18 mm. A hardness of the pressing roller 32 may desirably be, from the viewpoints of ensuring of a nip N and durability, in a range of 40-70 degrees as measured by an Asker-C hardness meter under a load of 9.8 N. In this embodiment, the hardness is adjusted to 54 degrees.

A length of the elastic layer 32b of the pressing roller 32 measured in a longitudinal direction is 226 mm. The pressing roller 32 is, as shown in FIG. 2, supported rotatably between the side plates 34 of the device frame via bearing members 35 at end portions of the core metal 32a. At an end portion of the pressing roller core metal 32a, a driving gear G is fixed. To the driving gear G, a rotational force is transmitted from a driving source (not shown), so that the pressing roller 32 is rotationally driven.

The film unit 31 shown in FIG. 1 includes the film 36, a planar heater 37 contacting an inner surface of the film 36 and used as a heat generating member, a supporting member 38 for supporting the heater 37, and a metal plate 39, as a thermal capacity member, sandwiched between the supporting member 38 and the heater 37. The film unit 31 further includes a pressing stay 41 for reinforcing the supporting member 38, flanges 42 for limiting movement of the film 36 in the longitudinal position, and the like.

The film 36 includes a base layer, an elastic layer formed outside the base layer and a parting layer formed outside the elastic layer, and is a cylindrical flexible member. The film 36 in this embodiment is 18 mm in inner diameter. In the film 36, as the base layer, a 60 μm-thick polyimide base material is used. As the elastic layer, an about 150 μm-thick silicone rubber layer is used. As the parting layer, a 15 mm-thick PFA resin tube is used.

The supporting member 38 has, as shown in FIG. 1, a substantially semicircular trough-like shape in cross section and has rigidity, a heat-resistant property and a heat-insulating property. In this embodiment, the supporting member 38 is formed of a liquid crystal polymer or the like. The supporting member 38 has the function of supporting the inner surface of the film 36 externally fitted with the supporting member 38 and the function of supporting a surface of the heater 37.

The heater 37 is, as shown in FIG. 3, prepared by forming two heat generating resistors 37b of silver-palladium alloy or the like on a substrate 37a of a ceramic material such as alumina or aluminum nitride by screen printing or the like and then by connecting an electrical contact portion 37c of silver or the like with the heat generating resistors 37b. In this embodiment, the two heat generating resistors 37b are connected in parallel, and a resistance value is 18Ω. On the heat generating resistors 37b, a glass coat 37d as a protective layer is formed, whereby the heat generating resistors 37b are protected and a sliding property with the film 36 is improved.

The heater 37 has an elongated shape and is provided along a generatrix direction (longitudinal direction, first direction) of the film 36 while opposing a supporting surface of the supporting member 38 so that the longitudinal direction is the first direction. The substrate 37a of the heater 37 has a rectangular parallelopiped shape which is 270 mm in length measured in the longitudinal direction, 5.8 mm in length measured in the short side direction and 1.0 mm in thickness, and a material thereof is alumina. The upstream and downstream heat generating resistors 37b have a pattern such that the heat generating resistors 37b are connected with each other by an electrical contact portion at one end portion with respect to the longitudinal direction, and have the same shape having a longitudinal length of 222 mm and a short-side length of 0.9 mm.

As regards short-side positions of the upstream and downstream heat generating resistors 37b, both the heat generating resistors 37b are disposed at positions of 0.7 mm from longitudinal edges of the ceramic substrate 37a, and the heat generating resistors 37b are printed at symmetrical positions with respect to a short-side center. Incidentally, onto the inner surface of the film 36, heat-resistant grease is applied, so that a sliding property of the inner surface of the film 36 with the heater 37 and the supporting member 38 are improved.

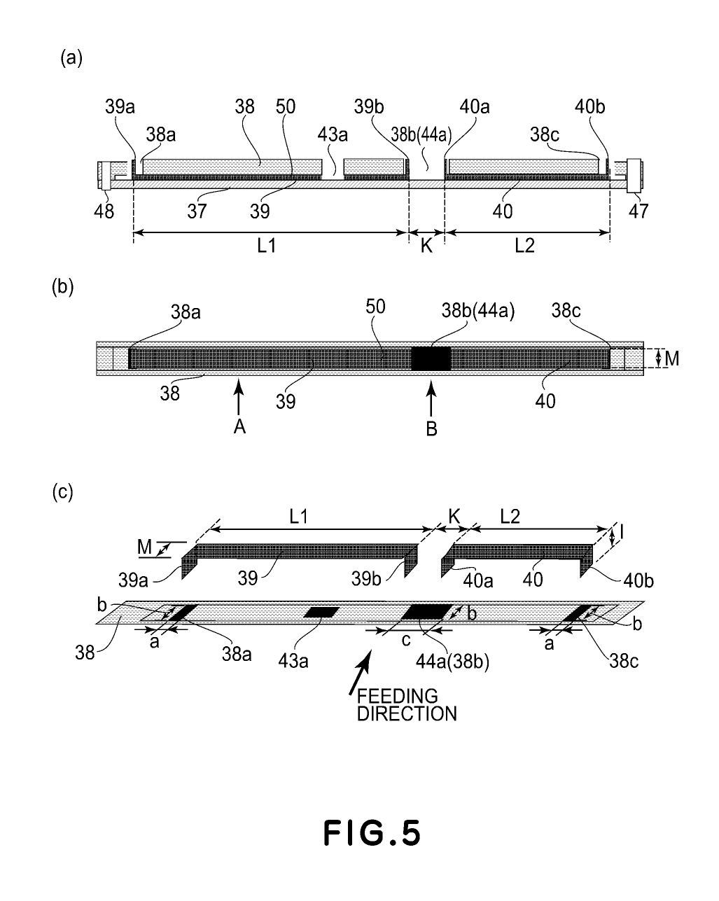

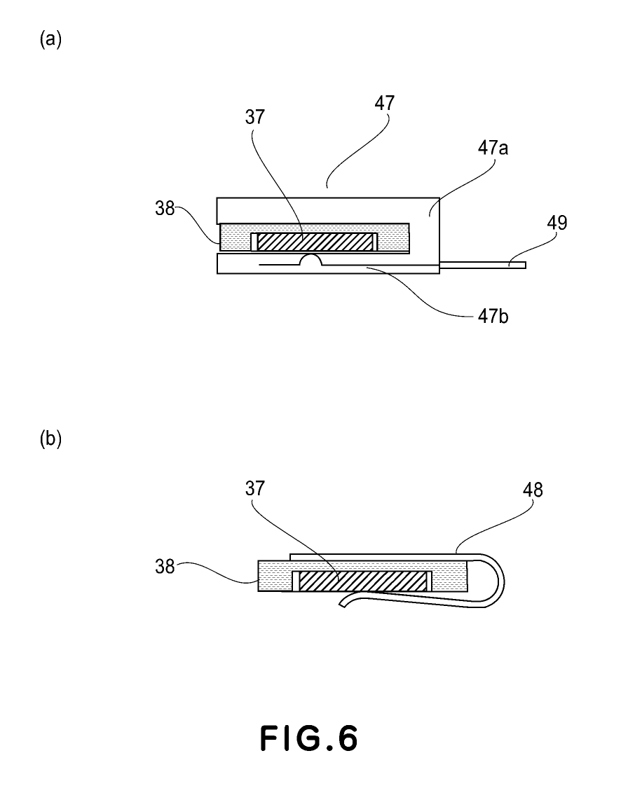

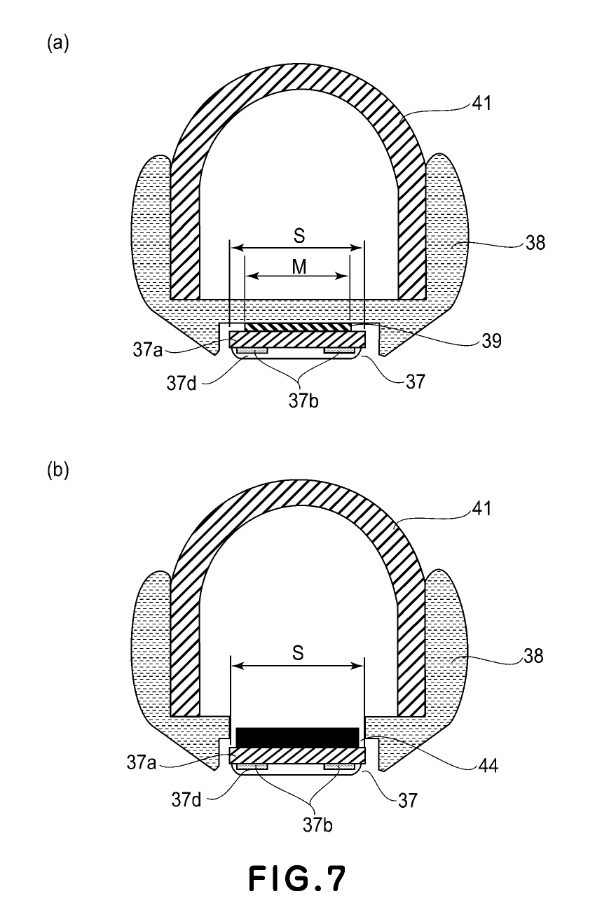

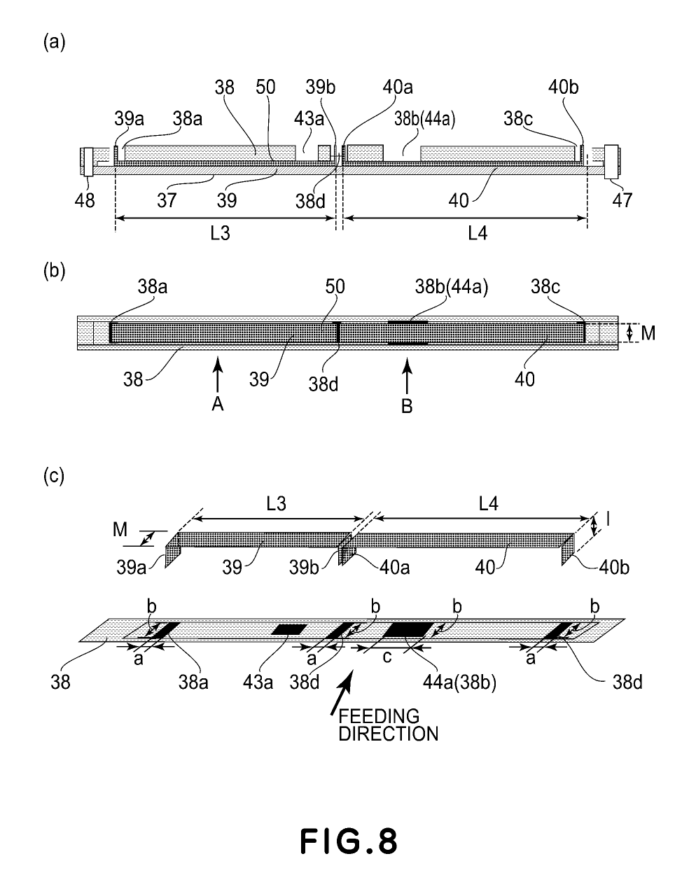

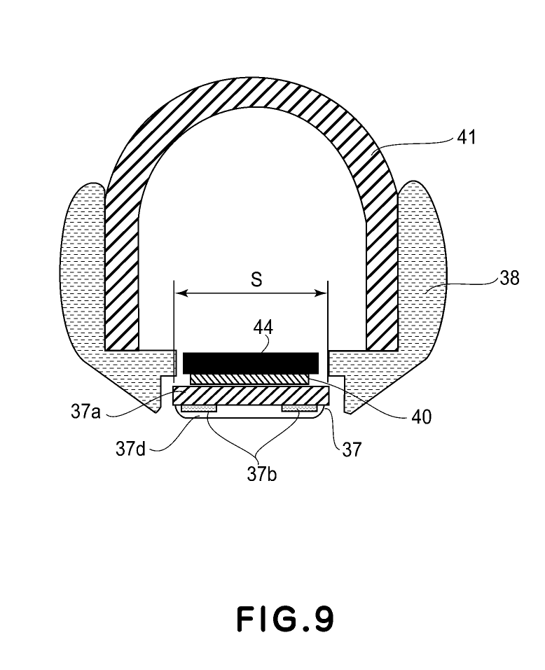

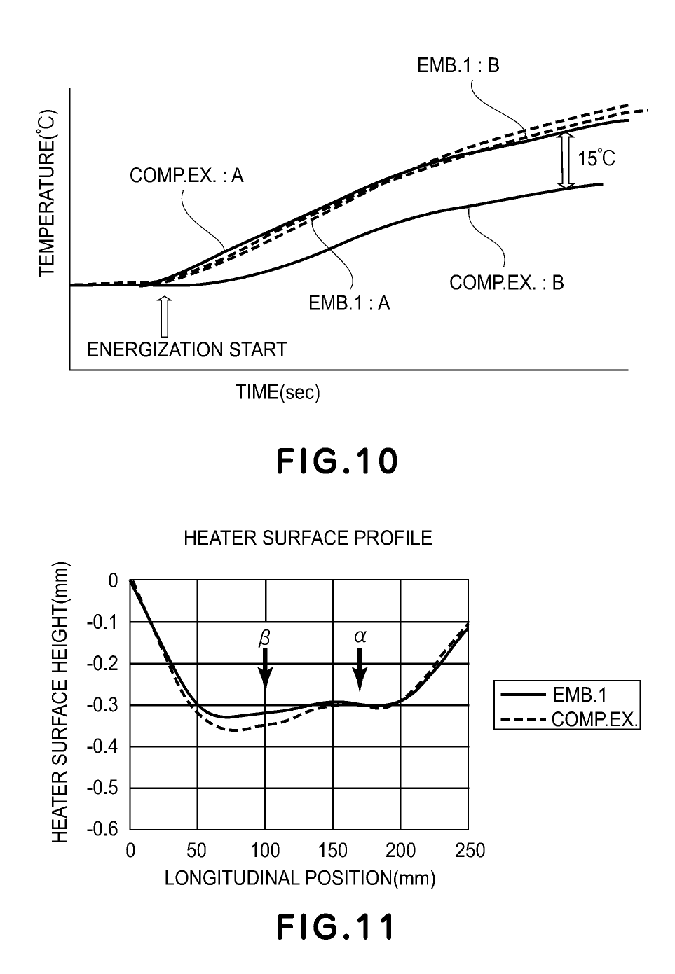

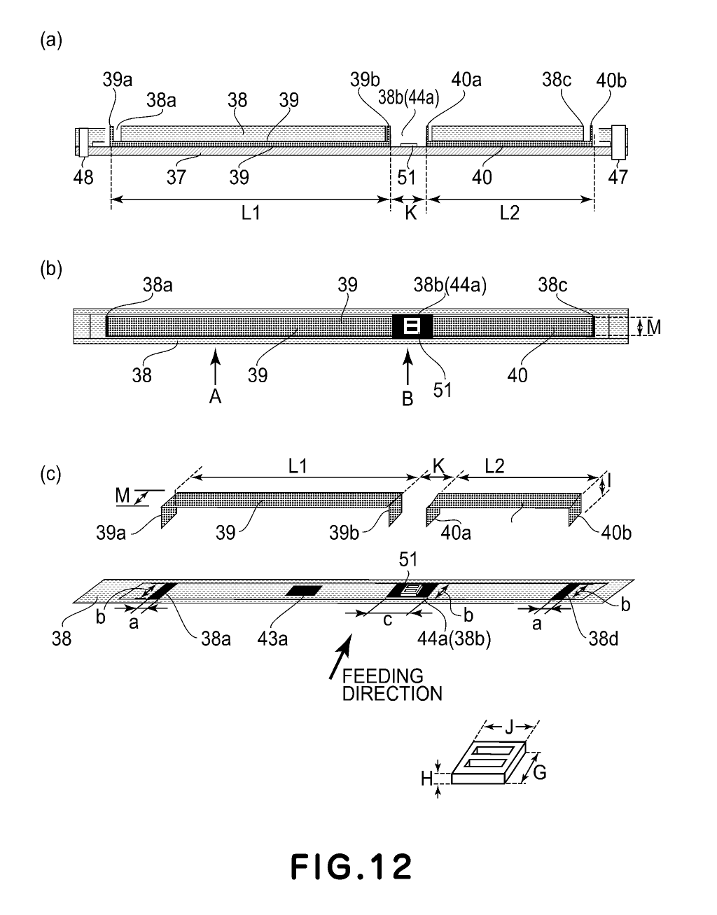

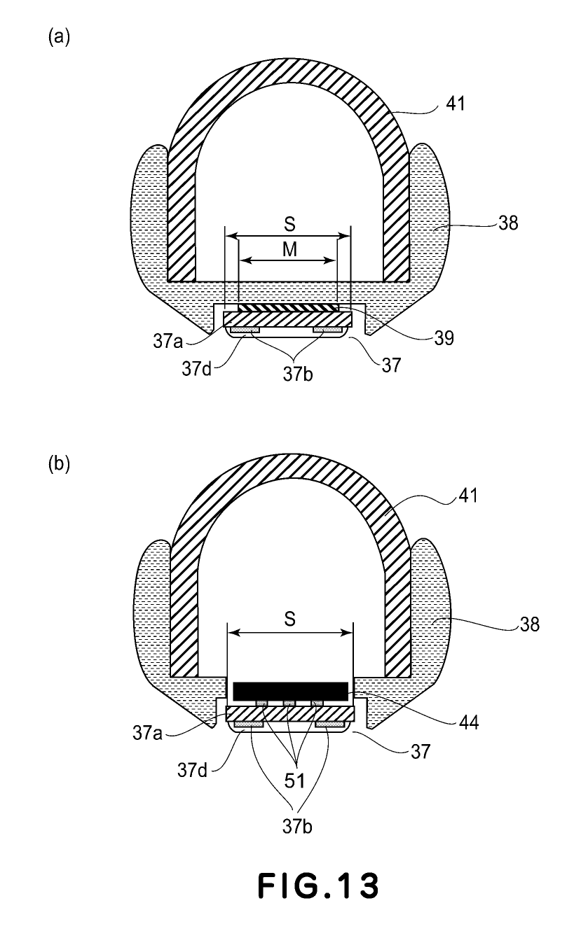

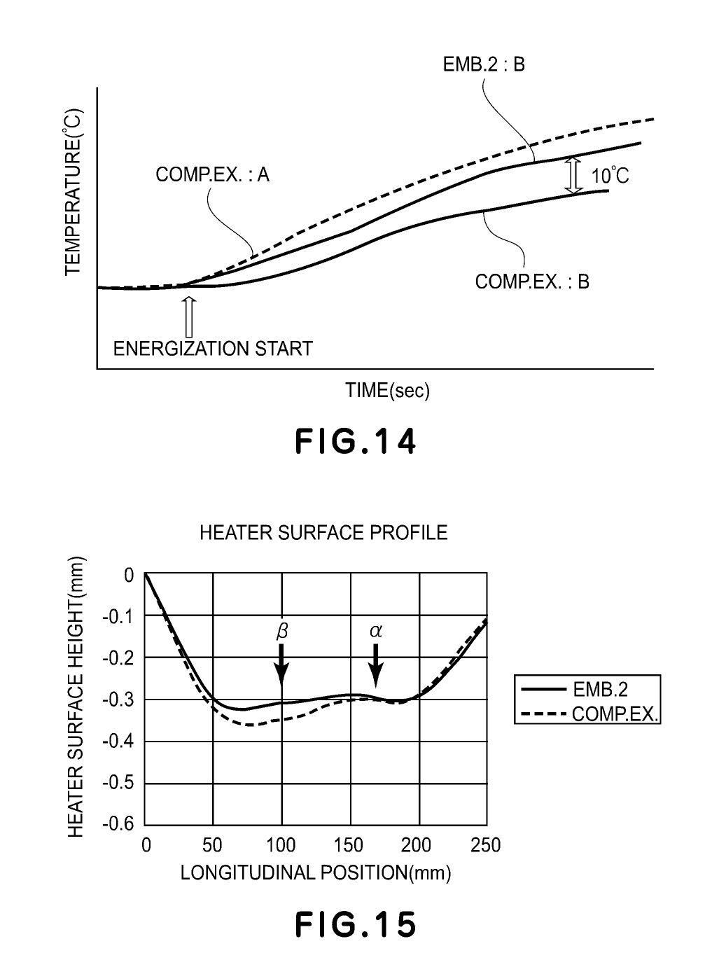

FIG. 4 is a top (plan) view of the supporting member 38, a thermistor 43 as a temperature detecting element (changed in electrical resistance with temperature change), and a thermo-switch 44 as an electric power shut-off member (overheating suppressing element, safety element) for shutting off electric power supplied to the heater 37. The supporting member 38 is provided with placement windows 43a and 43b as openings corresponding to the thermistor 43 and the thermo-switch 44, respectively, for permitting mounting and demounting of the thermistor 43 and the thermo-switch 44. The thermistor 43 includes a temperature element provided on a metal plate 39 so as to sense (detect) heat of the heater 37 through the metal plate 39.

On the other hand, the thermo-switch 44 is supported in direct contact with a back surface of the heater 37 so as to directly sense (detect) heat of the heater 3 without through the metal plate 39. A pressing force (pressure) of the thermo-switch 44 exerted on the back surface of the heater 37 is imparted by a spring (not shown) provided between the pressing stay 41 and a thermo-switch holder (not shown) for holding the thermo-switch 44.

The thermistor 42 is prepared by providing a thermistor element in a casing via ceramic paper or the like for stabilizing a contact state with the metal plate 39 and then by coating the thermistor element with an insulating material such as a polyimide tape. The thermo-switch 44 is a part for detecting abnormal heat generation to shut off electric power supply to the heater 37 when the heater 37 causes abnormal temperature rise. The thermo-switch 44 is provided with bimetal portion prepared by firmly bonding two or more kinds of metal or alloy different thermal expansion coefficient to each other and then by finishing the bonded material in a plate shape, so that due to abnormal high temperature of the heater 37, the metal portion having large thermal expansion coefficient is bent toward the metal portion side having small thermal expansion coefficient. By using this displacement, an electric contact is opened and closed, so that a circuit for supplying electric power (energization) to the heater 37.

Next, the pressing stay 41 shown in FIG. 1 has a U-shape in cross section and is an elongated member extending in the generatrix direction (longitudinal direction, layer direction) of the film 36. The function of the pressing stay 41 is to enhance the flexural rigidity of the film unit 31. The pressing stay 41 in this embodiment is formed by bending a 1.6 mm-thick stainless steel plate.

The left and right flanges 42 hold end portions of the pressing stay 41 with respect to the longitudinal direction, and a vertical groove portion 42a of each of the left and right flanges 42 is engaged with a vertical groove portion 34a of each of the left and right side plates 34 of the device frame 33. In this embodiment, as a material of the flanges 42, a liquid crystal polymer (resin) is used.

Then, as shown in FIG. 2, a pressing spring 46 is provided between a pressing arm 45 and a pressing portion 42b of each of the left and right flanges 42, so that the heater 37 is urged toward the pressing roller 32 via the left and right flanges 42, the pressing stay 41, the supporting member 38 and the film 36. In this embodiment, a press-contact force between the film 36 and the pressing roller 32 is 180N as total pressure. As a result, the film 36 backed up by the heater 37 forms, together with the pressing roller 32, a nip N of about 6 mm.

During an operation of the fixing device, to the driving gear G of the pressing roller 32, a rotational force is transmitted from an unshown driving source, so that the pressing roller 32 is rotationally driven in the clockwise direction in FIG. 1 at a predetermined rotational speed. In this embodiment, the rotational speed of the pressing roller 32 was set so that a recording material feeding speed was 100 mm/sec. With the rotational drive of the pressing roller 32, the rotational force acts on the film 36 by a frictional force acting between the pressing roller 32 and the film 36 in the nip N. As a result, as shown in FIG. 1, the film 36 slides on a surface of the heater 37 while contacting the heater 37 and is rotated in the counterclockwise direction around the supporting member 38 by rotation of the pressing roller 32.

The film 36 is rotated and the electric power is supplied to the heater 37, and in a state in which the temperature of the heater 37 detected by the thermistor 43 reaches the target temperature, the recording material (recording paper) P is introduced. A fixing entrance guide 30 performs the function of guiding the recording material P, on which a toner image tin an unfixed state is placed, so as to be moved toward the nip N.

Into the nip N, the recording material P carrying thereon the unfixed toner image t is introduced, and then a toner image-carrying surface of the recording material P is in close contact with the film 36 at the nip N and the recording material P is nipped and fed (conveyed) through the nip N. In this feeding process, the unfixed toner image t on the recording material P is heated and pressed by heat of the film 36 heated by the heater 37, and thus is melted and fixed on the recording material P.

The recording material P passing through the nip N is curvature-separated from the surface of the film 36 and then is discharged to an outside of the fixing device by an unshown discharging roller pair. Incidentally, a maximum sheet passable width of the fixing device is 216 mm, so that LTR (letter)-sized recording material is capable of being subjected to printing at a speed of 20 PPM.

(Feature of this Embodiment)

With reference to FIGS. 5 and 6, metal plates 39 and 40 as thermally capacitive members in this embodiment and a holding method thereof will be described. In FIG. 5, part (a) is a longitudinal sectional view of the heater 37 and the metal plates 39 and 40, part (b) is a schematic view showing a state in which the metal plates 39 and 40 are provided on the supporting member 38 in a state that the heater 37 is removed, and part (c) is a perspective view for illustrating a metal plate engaging portion. Incidentally, in FIG. 5, illustration of the thermistor 43 and the thermo-switch 44 is omitted.

As shown in parts (a) and (b) of FIG. 5, in this embodiment, the metal plates 39 and 40 are mounted on the supporting member 38, and thereon, the heater 37 is mounted. Further, as shown in parts (a) and (b) of FIG. 6, the longitudinal end portion of the heater 37 is held by an energizing connector 47 and a heater clip 48, respectively, which are end portion holding members, and are held in contact with an associated longitudinal end portion of the supporting member 38. A longitudinal central portion of the heater 37 is supported by the supporting member 38 via the metal plates 39 and 40 (part (a) of FIG. 5), and the longitudinal end portion of the heater 37 is supported in contact with the supporting member 38 (parts (a) and (b) of FIG. 6).

As shown in part (a) of FIG. 6, the energizing connector 47 is constituted by a housing portion formed of a resin member in a U-shape and by a contact terminal 47b. The energizing connector 47 holds the heater 37 and the supporting member 38 while sandwiching these members, and the contact terminal 47b contacts an electrode 37c (FIG. 3) of the heater 37, and thus the energizing connector 47 is electrically connected with the heater 37. In this embodiment, the energizing connector 47 was used as the end portion holding member for holding the heater 37, but its function may be divided into the function of energizing the heater 37 and the function as the end portion holding member for the heater 37, and thus the energizing connector 47 may also be constituted by separate members. In part (a) of FIG. 6, the contact terminal 47b is connected with a bundle wire 49, and the bundle wire 49 is connected with an unshown AC power source and a triac.

As shown in part (b) of FIG. 6, the heater clip 48 is formed of a metal plate bent in a V-shape and is used as an end portion holding member for holding the heater 37 based on its spring property, and holds the heater 37 by causing the end portion of the heater 37 to contact the supporting member 38. Further, the longitudinal end portion of the heater 37 pressed by the heater clip 48 is movable in an in-plane direction of the heater sliding surface. As a result, during thermal expansion of the heater 37, exertion of unnecessary stress on the heater 37 is prevented.

With reference to part (c) of FIG. 5, the metal plates 39 and 40 and engaging portions provided in the supporting member 38 will be described. In this embodiment, as the metal plates 39 and 40, an aluminum plate having a constant thickness of 0.3 mm is used. Each of the aluminum plates 39 and 40 includes a contact portion contacting the heater 37 and having a feeding direction width M of 4 mm. A width with respect to the longitudinal direction is L1=161 mm for the aluminum plate 39 and is L2=79 mm for the aluminum plate 40.

The aluminum plate 39 includes a first surface contacting the back surface of the heater 37 and bent portions 39a and 39b which are second surfaces (surfaces extending from longitudinal ends of the first surface in a direction of being spaced from the heater 37 (opposite direction from the heater 37)) provided at longitudinal end portions thereof and which are bent at right angle with a length l=3 mm. The bent portions 39a and 39b are inserted in mounting holes 38a and 38b, respectively, provided as openings in the supporting member 38, so that movement of the aluminum plate 39 is prevented. Similarly, the aluminum plate 40 includes bent portions 40a and 40b provided as second surfaces at longitudinal end portions thereof, and the bent portions 40a and 40b are inserted in mounting holes 38b and 38c, respectively.

The mounting holes 38a and 38c have the same size and are provided somewhat larger (error amount Δ of 1 mm or less) than the associated bent portions in order to absorb thermal expansion of the aluminum plates 39 and 40. In this embodiment, a=0.4 mm and b=4.1 mm are set. The mounting hole 38b for mounting the supporting member 38 on a device frame 33 also functions as the placement window 44a in a state in which the supporting member 38 is demounted from the device frame 33, and in this embodiment, b=4.1 mm and c=15.1 mm are set. Thus, a constitution in which the thermo-switch 44 is provided at a position corresponding to a second region of the heater 37 where the heater 37 does not contact the aluminum plate 39, and the supporting member 38 is provided, at a position corresponding to the second region, with the mounting hole 38b for preventing movement of the aluminum plate 39 and supports the heater 37 via the aluminum plate 39 is employed. That is, the supporting member 38 is provided with the placement window 44a at a portion corresponding to the second region, where the heater 37 does not contact the aluminum plate 39, different from the first region where the heater 37 contacts the aluminum plate 39, with respect to the longitudinal direction of the heater 37.

Parts (a) and (b) of FIG. 7 are sectional views of the fixing device in this embodiment as seen in the longitudinal direction of the fixing device. Part (a) of FIG. 7 is the sectional view taken along an arrow A of part (b) of FIG. 5. The heater 37 is received by the aluminum plate 39 on the supporting member 38. A heater substrate width S is 5.8 mm, and a feeding direction width M of the aluminum plate 39 is 4 mm. Further, part (b) of FIG. 7 is the sectional view of the fixing device in a gap between the aluminum plates 39 and 40 taken along an arrow B of part (b) of FIG. 5. In a gap K between the aluminum plates 39 and 40, the thermo-switch 44 is disposed and directly contacts the heater 37 without via the aluminum plate. That is, between the heater 37 and the thermo-switch 44, heat conduction between the heater 37 and the thermo-switch 44 during normal use is suppressed.

The thickness of the aluminum plates 39 and 40 is 0.3 mm, and therefore, when the above-described error amount Δ is taken into consideration, as regards the gap K between the aluminum plates 39 and 40, the following formula is satisfied.

K+0.3×2+Δ=15.1

(Action of this Embodiment)

Parts (a) to (c) of FIG. 8 are schematic views of a heater and metal plates in a comparison example, in which part (b) is the schematic view of the members with respect to the longitudinal direction, part (b) is the schematic view showing a state in which the aluminum plates 39 and 40 are provided on the supporting member 38 in a state that the heater 37 is removed, and part (c) is a perspective view for illustrating engaging portions of the aluminum plates 39 and 40. In this comparison example, the aluminum plate 39 contacts the thermistor 43, and the aluminum plate 40 contacts the thermo-switch 44. The bent portion 40a of the aluminum plate 40 is inserted in a mounting hole 38d different from the placement window 44a of the thermo-switch 44. FIG. 9 is a sectional view of a gap between the aluminum plates taken along an arrow B of part (b) of FIG. 8.

FIG. 10 shows heater back surface temperature changes at thermo-switch positions in this embodiment and the comparison example. In FIG. 10, heater back surface temperatures from a start of energization to the heaters are measured by a thermocouple (changed in electromotive force with a temperature change) mounted on the back surface of the heater 37 at a central portion with respect to a recording material feeding direction. Further, with respect to the longitudinal direction (first direction), the temperatures at portions A and B of part (b) of FIG. 5 in this embodiment and the temperatures at portions A and B of part (b) of FIG. 8 in the comparison example were measured.

In the comparison example, when the heater back surface temperatures of the heater 37 after a lapse of 3 sec from the start of energization are such that the temperature at the portion B is lower than the temperature at the portion A by about 17° C., and on the other hand, in this embodiment, the temperature at the portion B is merely lower than the temperature at the portion A by about 2-3° C. The portions A in this embodiment and the comparison example are unchanged in constitution between this embodiment and the comparison example, and therefore, the temperature changes at the portions A are substantially the same. When comparison is made at the portions B, it is understood that the heater back surface temperature in this embodiment higher about 15° C. than the heater back surface temperature in the comparison example.

As a result of printing of the image in this state, in the comparison example, improper fixing generated at the thermo-switch 44 portion in printing of the image on a first sheet. This is because the back surface temperature of the heater 37 locally becomes a low temperature, so that the film surface temperature at this portion also lowers. When the film surface temperature in the comparison example was measured using a radiation thermometer, it turned out that immediately before the printing of the image on the first sheet, the temperature at the portion B was lower about 5° C. than at the portion A.

The improper fixing remarkably generates immediately after the fixing device is increased in temperature up to a fixing temperature from a state of being sufficiently cooled at normal temperature, and when the printing is repeated, the heater back surface temperature is uniformized, and therefore, the improper fixing gradually does not generate. In the comparison example, the improper fixing slight generates in the printing of the image on a second sheet and disappeared in the printing of the image on a third sheet.

On the other hand, in this embodiment, the heater back surface temperature was uniform compared with that in the comparison example, so that the improper fixing did not generate even in the printing of the image on the first sheet and a good image was able to be obtained. This is because by disposing the aluminum plate on the heater back surface at a position other than the position of the thermo-switch 44, the temperature is controlled in a state in which values of thermal capacitance at portions where the thermo-switch is present and absent are added to each other, and thus a local temperature lowering does not generate at the position of the thermo-switch 44.

Strength of the supporting member 38 will be described using FIG. 11. FIG. 11 is a graph showing a result of measurement of a height of a surface of the heater 37 when a voltage of 145 V is applied for about 7 sec on the assumption of temperature rise of the heater 37 due to voltage source (power) circuit failure. An arrow α shows a heater surface height at a position of the placement window 44a where the thermo-switch 44 is disposed. On the other hand, an arrow β shows a heater surface height at a position of the mounting hole 38d in the comparison example.

At the arrow α portion, there is no difference in heater surface height between this embodiment and the comparison example, so that a sag of the supporting member 38 does not generate. This would be considered because the thermo-switch 44 backs up the sheet 38 in press-contact with the back surface of the heater 37 and thus suppresses the sag of the supporting member 38.

On the other hand, the heater surface height at the arrow β portion in the comparison example is lower about 0.03 mm than that in this embodiment. This is because the mounting hole 38d is provided at the arrow β portion in the comparison example and the strength of the supporting member 38 weakens from the mounting hole 38d as a starting point, and thus deformation of the supporting member 38 due to the sag in the neighborhood of the mounting hole 38d.

As described above, in this embodiment, the metal plate is disposed as a thermal capacitance member on the heater back surface at the position other than the position of the thermo-switch 44, and the temperature is controlled in a state in which values of thermal capacity at portions where the thermo-switch 44 is present and absent are added to each other, so that a local temperature lowering at the position of the thermo-switch 44 is avoided.

Further, in this embodiment, the supporting member 38 is provided with the opening, corresponding to the thermo-switch 44, at the position opposing the second region different in position with respect to the longitudinal direction (first direction) of the heater 37 from the first region where the heater 37 contacts the aluminum plate 39. By contact between a second surface of the aluminum plate 39 and an end surface of the opening of the supporting member 38 with respect to the first direction, movement of the aluminum plate 39 relative to the supporting member 38 is prevented. Further, the aluminum plate 39 is constituted so that the portion corresponding to the second region of the heater 37 contacts the thermo-switch 44. Further, the positioning hole of the metal plate relative to the metal plate is caused to function as the B placement window (opening) of the thermo-switch 44, so that the sag caused by the lowering in strength of the supporting member 38 due to the positioning hole is avoided.

As a result, the generation of the improper fixing due to the local temperature lowering of the heater (heat generating member) while maintaining a heat-uniformizing effect by a conventional high heat conductive member, and the sag of the heater supporting member due to the lowering in strength of the supporting member is avoided, so that a good image can be formed.

### Second Embodiment

In First Embodiment, the constitution in which the thermo-switch was directly contacted to the back surface of the heater without via the metal plate so as to suppress the heat conduction between the heater and the thermo-switch during normal use was employed. In this embodiment, in order to further suppress the heat conduction between the heater and the thermo-switch during normal use, a spacer member is used between the heater and the thermo-switch. An outline of a fixing device in this embodiment is the same as that of the fixing device in First Embodiment, and therefore, is omitted, and only a feature of this embodiment will be described.

(Feature of this Embodiment)

Parts (a) to (c) of FIG. 12 are schematic views for illustrating the heater and metal plates in this embodiment, in which part (b) is a longitudinal sectional view of the heater and the metal plates in this embodiment, part (b) is the schematic view of a state in which the aluminum plates 39 and 40 are provided on the supporting member 38 in a state that the heater 37 is removed, and part (c) is a perspective view for illustrating an aluminum plate engaging portion and the spacer member. In part (c) of FIG. 12, a spacer member (spacer) 51 for the thermo-switch 44 is disposed between the aluminum plates 39 and 40 and may preferably have a heat-resistant property capable of withstanding a normal temperature of the heater 37 and thermal capacity equal to or less than the thermal capacity of the supporting member 38.

The thermo-switch 44 has large thermal capacity, and therefore, the heat of the heater 37 does not readily conduct to the fixing film 36 contacting the (front) surface of the heater 37 compared with other members (the supporting member 38 and the thermistor 43) disposed on the back surface side of the heater 37. As a result, fixing non-uniformity and uneven glossiness of the toner image t on the recording material P. In this embodiment, the spacer 51 formed of a resin material for the thermo-switch 44 is sandwiched between the heater 37 and the thermo-switch 44, so that the thermo-switch 44 and the back surface of the heater 37 are placed in a non-(direct) contact state.

As a result, a gap between the heater 37 and the thermo-switch 44 is fixed while suppressing the heat conduction between the heater 37 and the thermo-switch 44, so that the thermo-switch 44 can be stably operated while eliminating the fixing non-uniformity and the uneven glossiness of the toner image t on the recording material P. Parts (a) and (b) of FIG. 13 are sectional views of arrows A and B portions, respectively, of FIG. 12.

A size of the spacer 51 is J=4 mm in width measured in the longitudinal direction (first direction), G=3 mm in width measured in the recording material feeding direction, and H=0.5 mm in height. Further, via this spacer 51, the thermo-switch 44 is supported so as to be pressed toward the back surface of the heater 37. That is, the supporting member 38 is constituted so that the thermo-switch 44 and the spacer 51 are in contact with each other at a portion corresponding to the second region different from the first region, where the heater 37 contacts the aluminum plate 39, with respect to the longitudinal direction of the heater 37. In this embodiment, as a material of the spacer 51, LCP was used.

(Action of this Embodiment)

A comparison example compared with this embodiment is the same as the comparison example compared with First Embodiment and shown in FIGS. 8 and 9.

FIG. 14 shows heater back surface temperature changes at thermo-switch positions in this embodiment and the comparison example. In this embodiment, the temperatures at portions A and B of part (b) of FIG. 5 are measured, and in the comparison example, the temperatures at portions A and B of part (b) of FIG. 8 are measured. The portions A in this embodiment and the comparison example are unchanged in constitution between this embodiment and the comparison example, and the temperature changes at the portions A are substantially the same, and therefore, the temperature change at the portion A in this embodiment is omitted. When comparison is made at the portions B, it is understood that the heater back surface temperature in this embodiment higher about 10° C. than the heater back surface temperature in the comparison example.

As a result of printing of the image in such a state, in the comparison example, improper fixing generated at a position of the thermo-switch 44 portion in printing of the image on a first sheet, and slight generates in the printing of the image on a second sheet and disappeared in the printing of the image on a third sheet.

On the other hand, in this embodiment, the heater back surface temperature was uniform compared with that in the comparison example, so that the improper fixing did not generate even in the printing of the image on the first sheet and a good image was able to be obtained. This is because the thermo-switch 44 and the back surface of the heater 37 are in a non-contact state by the spacer 51 and thus the heat conduction between the heater 37 and the thermo-switch 44 is suppressed with the result that a local temperature lowering at the position of the thermo-switch 44 is suppressed.

Strength of the supporting member 38 will be described using FIG. 15. FIG. 15 is a graph showing a result of measurement of a height of a surface of the heater 37 when a voltage of 145 V is applied for about 7 sec on the assumption of temperature rise of the heater 37 due to voltage source (power) circuit failure, similarly as in First Embodiment. An arrow α shows a heater surface height at a position of the placement window 44a where the thermo-switch 44 is disposed, and an arrow β shows a heater surface height at a position of the mounting hole 38d (FIG. 8) in the comparison example.

At the arrow α portion, there is no difference in heater surface height between this embodiment and the comparison example, so that a sag of the supporting member 38 does not generate.

The heater surface height at the arrow β portion in the comparison example is lower about 0.05 mm than that in this embodiment. This is because similarly as in the comparison example described in First Embodiment, the mounting hole 38d is provided at the arrow β portion in the comparison example and the strength of the supporting member 38 weakens from the mounting hole 38d as a starting point, and thus deformation of the supporting member 38 due to the sag in the neighborhood of the mounting hole 38d.

As described above, in this embodiment, the metal plate is disposed as a thermal capacitance member on the heater back surface at the position other than the position of the thermo-switch 44, and the temperature is controlled in a state in which values of thermal capacity at portions where the thermo-switch 44 is present and absent are added to each other, so that a local temperature lowering at the position of the thermo-switch 44 is avoided.

Further, in this embodiment, the spacer member is provided between the heater and the thermo-switch, so that the heat conduction between the heater and the thermo-switch during normal use can be further suppressed.

Further, the positioning hole of the metal plate relative to the metal plate is caused to function as the B placement window of the thermo-switch 44, so that the sag caused by the lowering in strength of the supporting member 38 due to the positioning hole can be avoided.

As a result, the generation of the improper fixing due to the local temperature lowering of the heater (heat generating member) while maintaining a heat-uniformizing effect by a conventional high heat conductive member, and the sag of the heater supporting member due to the lowering in strength of the supporting member is avoided, so that a good image can be formed.

### MODIFIED EMBODIMENTS

In the above, preferred embodiments of the present invention were described. However, the present invention is not limited to these embodiments, but can be variously modified and changed within the scope of the present invention.

### Modified Embodiment 1

In the above-described embodiments, the bent portions 39b and 40b as the second surfaces of the heat conductive members 39 and 40 including the first surface contacting the heater were used as the positioning portions positioned relative to the opening 44a of the supporting member 38, but the present invention is not limited thereto.

Positioning members corresponding to the bent portions 39 and 40b as the second surfaces of the heat conductive members 39 and 40 are provided integrally with the heat conductive members 39 and 40 and may also be positioned relative to the opening 44a of the supporting member 38. In this case, the positioning members are not necessarily required to have heat conductivity, and may also be formed of, for example, a resin member, not the metal material. Further, as regards the heat conductive members 39 and 40, the first surface contacting the heater and the second surfaces (39a, 40a) as the positioning portions have the same thickness, but the positioning members may also have a thickness different from (for example, larger than) the thickness of the first surface of the heat conductive members contacting the heater.

### Modified Embodiment 2

In the above-described embodiments, description was made on the pressure that a heat generation distribution of the heat generating resistor with respect to the longitudinal direction (first direction) of the heater as the heat generating member, but the present invention is not limited thereto. The shape of the heat generating resistor may also be changed so that an amount of heat generation is larger at the position of the thermo-switch 44 than at another position with respect to the longitudinal direction (first direction). As a result, the generation of the improper fixing due to the local temperature lowering of the heater (heat generating member) can be further suppressed.

### Modified Embodiment 3

In the above-described embodiments, the thermo-switch 44 as the electric power shut-off member for suppressing overheat of the heater as the heat generating member was described, but the present invention is not limited thereto, and another element having large thermal capacity can be used.

### Modified Embodiment 4

In the above-described embodiments, as the opposing member, the pressing roller for pressing the endless belt was used, but the endless belt may also be used as the opposing member. The opposing member is not limited to an opposing member for pressing the endless belt as the rotatable fixing member, but may also be an opposing member to be pressed.

### Modified Embodiment 5

In the above-described embodiments, as the recording material, the recording paper was described, but the recording material in the present invention is not limited to the paper. In general, the recording material is a sheet-like member on which the toner image is formed by the image forming apparatus and includes, for example, regular or irregular materials, such as plain paper, thick paper, thin paper, an envelope, a postcard, a seal, a resin sheet, an OHP sheet, and glossy paper. In the above-described embodiments, for convenience, handling of the recording material P was described using terms such as the sheet passing or the sheet discharge, but by these terms, the recording material in the present invention is not limited to the paper.

### Modified Embodiment 6

In the above-described embodiments, the fixing device for fixing the unfixed toner image on the sheet was described as an example, but the present invention is not limited thereto. The present invention is also similarly applicable to a device for heating and pressing a toner image temporarily fixed on the sheet in order to improve a gloss (glossiness) of an image (also in this case, the device is referred to as the fixing device).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-107780 filed on May 31, 2017, which is hereby incorporated by reference herein in its entirety.

What is claimed is:

1. A fixing device comprising:
an elongated heat generating member extending in a longitudinal direction and having a first region and a second region different in the longitudinal direction;
an endless belt rotatable in contact with said heat generating member;
an opposing member opposing said endless belt and configured to form a nip in cooperation with said endless belt so that a recording material on which a toner image is carried is nipped and fed in the nip;
a heat conductive member extending in the longitudinal direction within the first region in which a surface of said heat conductive member contacts said heat generating member;
a positioning portion extending from an end portion of the surface of said heat conductive member with respect to the longitudinal direction, in a direction in which said positioning portion is spaced from said heat generating member;
an electric power shut-off member provided at a position corresponding to the second region of said heat generating member and configured to shut off electric power supplied to said heat generating member; and
a supporting member provided with an opening at a position corresponding to the second region and configured to support said heat generating member through said heat conductive member, wherein said opening is configured to permit insertion of said positioning portion to prevent movement of said heat conductive member.

2. A fixing device according to claim 1, wherein said heat conductive member is formed of a metal material.

3. A fixing device according to claim 1, wherein said positioning portion is a part of said heat conductive member.

4. A fixing device according to claim 1, wherein said electric power shut-off member is provided in non-contact with said heat generating member in the second region.

5. A fixing device according to claim 4, further comprising a temperature detecting element provided in contact with said heat generating member without through said heat conductive member in a third region provided in a position different from the first and second regions of said heat generating member with respect to the longitudinal direction and configured to detect a temperature of said heat generating member.

6. A fixing device according to claim 5, wherein said supporting member is provided with an opening corresponding to said temperature detecting element.

7. A fixing device according to claim 1, further comprising a spacer member provided in the second region of said heat generating member in contact with said heat generating member,
wherein said electric power shut-off member contacts said spacer member at a portion thereof corresponding to the second region of said heat generating member.

8. A fixing device according to claim 7, wherein said spacer member is formed of a resin material.

9. A fixing device according to claim 7, wherein said heat conductive member is formed of a metal material.

10. A fixing device according to claim 7, wherein said positioning portion is a part of said heat conductive member.

11. A fixing device according to claim 7, further comprising a temperature detecting element provided in contact with said heat generating member without through said heat conductive member in a third region provided in a position different from the first and second regions of said heat generating member with respect to the longitudinal direction and configured to detect a temperature of said heat generating member.

12. A fixing device according to claim 11, wherein said supporting member is provided with an opening corresponding to said temperature detecting element.
